(19) United States
(12) Patent Application Publication
(10) Pub. No.: US 2006/0232923 A1
(43) Pub. Date: Oct. 19, 2006

(54) Transfer apparatus of detachable disk drive

(75) Inventor: Shun Ying Liang, Taoyuan Hsien (TW)

Correspondence Address: TROXELL LAW OFFICE PLLC, SUITE 1404, 5205 LEESBURG PIKE, FALLS CHURCH, VA, 22041, US

(73) Assignee: T-Win Sheet Metal Co., Ltd.

(21) Appl. No.: 11/130,089

(22) Filed: May 17, 2005

(30) Foreign Application Priority Data
Apr. 18, 2005 (TW) 094206056

(51) Int. Cl. G06F 1/16

(52) U.S. Cl. 361/685

(57) ABSTRACT

A transfer apparatus of detachable many hard disk drives by transferring two 5.25 inches of the computer disk case space, which utilizes a transfer frame body occupying two normal 5.25 inches computer disk case space and places many sliding trough inside the transfer frame body to slide the hard disk drive into the sliding trough by using the detachable support seat used to support the hard disk drive and also fix right in the position, or to release the fixation to withdraw the detachable support seat and accordingly makes many hard disk drives easily fixed, installed, withdrawn, maintained and managed.

### FIELD OF THE INVENTION

This invention is to provide a computer hard disk transfer apparatus for many hard disk drives by using the sliding and detachable support seat used to support the hard disk drive and accordingly makes many hard disk drives easily fixed, installed, withdrawn, maintained and managed as the property.

### BACKGROUND OF THE INVENTION

The popularization of using computers benefits people in making life convenient and furthers the frequent renewal of computer technology, recently making the operational range of computer systems much wider and more efficient. It results in information storage demanding high speed and high capacity; however, the usual storage medium is the hard disk drive and it is therefore commonly used as the storage and switch medium of the information.

The common usage of the hard disk drive is to fix inside the personal computer, as externally connecting hard disk drive, or fixed inside the hard disk drive framecase of industrial computers or servers. Therefore, one has to disassemble the computer case or the externally connected hard disk drive case first while installing or replacing the hard disk drive, and/or fasten or loosen the screws on both sides of the hard disk drive casecase. This results in the complexity and inconvenience of changing or repair management and therefore increases the maintenance time and expense. So to utilize the available space inside the hard disk drive in order to transfer into the efficiently practical function and simplify the installation, usage and maintenance of the hard disk drive is the main function and purpose of the present invention.

As is well known, there are units of 5.25 inch disk drive ??????? to install hard disk drives or optical disk drives in the disk case of the usual standard computer body, externally connected disk drive or the server. In practice, the idle 5.25 inches disk drive trough is usually covered by a sheltering plate, however, the present invention transfer apparatus of detachable disk drive is to provide a transfer apparatus of detaching many hard disk drives by transferring two 5.25 inches of the computer disk case space, which utilizes a transfer frame body occupying two normal 5.25 inch computer disk case spaces and places many sliding troughs inside the transfer frame body to slide the hard disk drive into the sliding trough by using the detachable support seat used to support the hard disk drive and also fix right in the position, or to release the fixture to withdraw the detachable support seat and accordingly allow many hard disk drives to be easily fixed, installed, detached, maintained and managed as the property.

### SUMMARY OF THE INVENTION

The present invention is to provide a transfer apparatus of detaching many hard disk drives by transferring two 5.25 inch computer disk case spaces, which utilize a transfer frame body occupying two normal 5.25 inch computer disk case spaces and places many sliding trough inside the transfer frame body to slide the hard disk drive into the sliding trough by using the detachable support seat used to support the hard disk drive and also fix right in the position, or to release the fixation to withdraw the detachable support seat and accordingly makes many hard disk drives easily fixed, installed, withdrawn, maintained and managed as the property.

### BRIEF DESCRIPTION OF DRAWINGS

FIG. 1 shows the operating 3-D figure of the present invented transfer apparatus of detachable disk drive in the embodiment.

FIG. 2 shows the 3-D figure of the present invented transfer frame body.

FIG. 3 shows the decomposed 3-D figure of the present invented detachable support seat.

FIG. 4 shows another viewing decomposed 3-D figure of the present invented detachable support seat.

FIG. 5 shows the operating 3-D figure of the present invented detachable support seat in the embodiment.

### DESCRIPTION OF THE PREFERRED EMBODIMENT

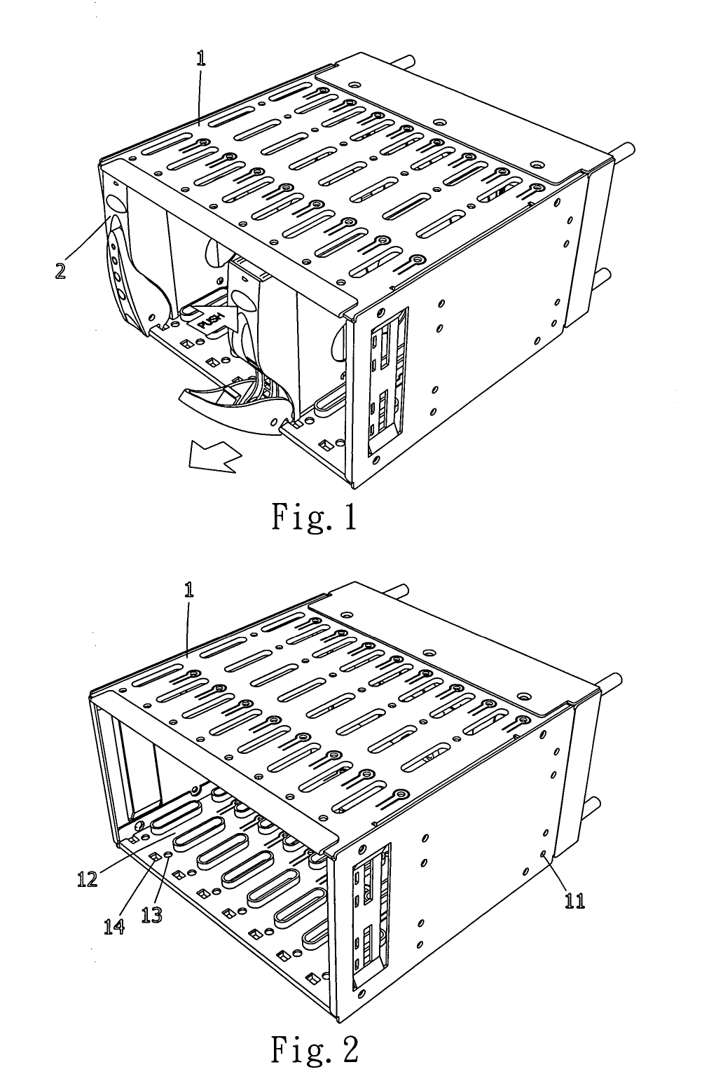

Referring to FIG. 1, the present invented apparatus mainly comprises a transfer frame body 1 and plural detachable support seats 2.

Referring to FIG. 2, transfer frame body 1 is the frame body occupying two 5.25 inch computer disk case spaces, and there preserve screw holes 11 corresponding to the screw holes in the disk drive case of the computer host, externally connected disk drive and the server on both sides. There place plural sliding troughs 12 along the longitude of transfer frame body 1, the front edge of sliding trough 12 is also placed screw hole 13 and fastener trough 14 and transfer frame body 1 is possible to be screwed and fixed inside two 5.25 inch computer disk drive case spaces in the disk drive case of the computer host, externally connected disk drive or the server.

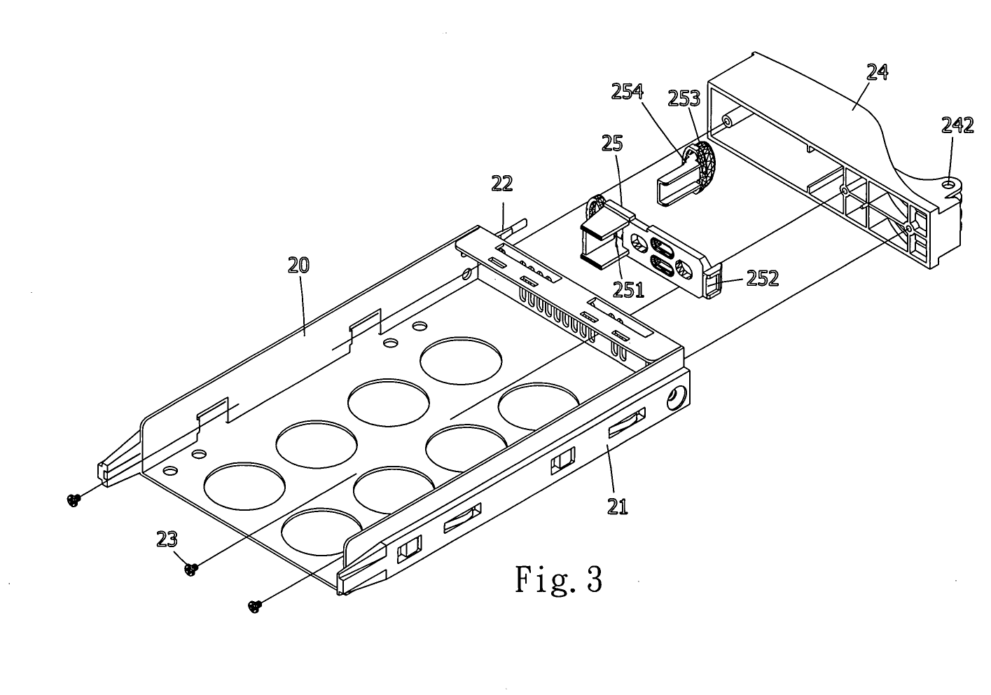

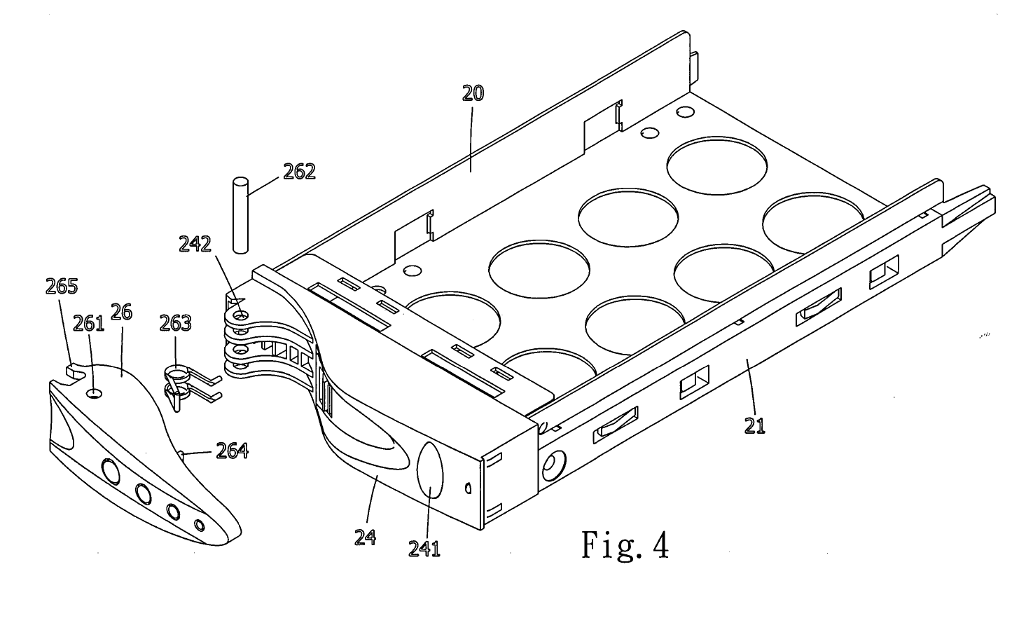

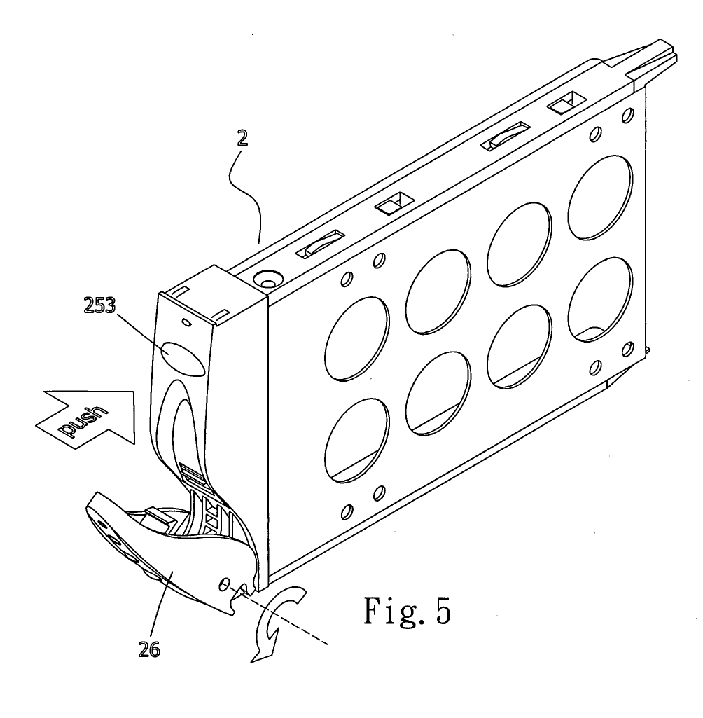

And further referring from FIG. 3 to FIG. 5, the backend of detachable support seat 2 is support plate 20, the central interior is possible to offer for fixing the hard disk drive, and there also place guiding rails 21 on both sides of support plate 20, wherein there fixes a guide light pillar 22 on one side and there fixes a front cover plate 24 on the front end of support plate 20 by the screw 23.

The interior wall of front cover plate 24 places a sliding piece 25, one side of sliding piece 25 places a through hole 251 and the other side preserves a fastener hole 252, wherein the terminal part of push button 253 is capable of entering into through hole 251 and places a slanted pyramidal face 254, one externally edge side of front cover plate 24 places a push button hole 241 and an axle hole 242, and one end of the above push button 253 locates at push button hole 241.

A rotating pull bar 26 corresponding to the above axle hole 242 of front cover plate 24 similarly places a axle hole 261 which is inserted by an axle 262 and added a spring 263 to combine rotating pull bar 26 with front cover plate 24 and reveal rotatable. The interior wall of rotating pull bar 26 corresponding to fastener hole 252 of the above sliding piece 25 places a hook 264 and places also the fastener hook 265 on one side corresponding to the above fastener trough 14 of transfer frame body 1.

Referring to FIG. 1 again, transfer frame body 1 is possible to be screwed inside two 5.25 inch computer disk case spaces in the disk drive case of the computer host, externally connected disk drive or the server in practice, and plural detachable support seats 2 of carrying hard disk drives slide into sliding trough 12 placed in the longitude of transfer frame body 1 along guiding rail 21 on both sides in the vertical direction, it is also to rotate rotating pull bar 26 of transfer frame body 1 to fix the hook 264 inside rotating pull bar 26 on fastener hole 252 of sliding piece 25 to position rotating pull bar 26 and again fix fastener hook 265 of the above corresponding transfer frame body 1 of one side on fastener trough 14 of transfer frame body 1 to position detachable support seat 2 on transfer frame body 1.

While depressing push button 253 of front cover plate 24, hook 264 of rotating pull bar 26 departs from the fastener of fastener hole 252 of sliding piece 25 and fastener hook 265 departs from the fastener of fastener trough 14 of transfer frame body 1 to withdraw detachable support seat 2 from the fastener of transfer frame body 1.

Accordingly, it is possible to provide a transfer apparatus of detachable many hard disk drives by transferring two 5.25 inches of the computer disk case space and also makes many hard disk drives easily fixed, installed, withdrawn, maintained and managed as the property.

What is claimed is:

1. A transfer apparatus of detachable disk drive, being capable of transferring two 5.25 inches computer disk case space into the transfer apparatus of detachable and positioning plural hard disk drives, mainly comprising:
A transfer frame body 1, being the frame body of occupying two 5.25 inches computer disk case space, wherein there preserve screw hole 11 corresponding to the screw hole of the disk drive case of the computer host, externally connected disk drive or the server on both sides, and also transfer frame body 1 places plural sliding troughs 12 in the longitude, the front edge of sliding trough 12 places screw hole 13 and fastener trough 14, transfer frame body 1 is capable of fix inside the two 5.25 inches computer disk case space of the computer host, externally connected disk drive or the server;
Plural detachable support seat 2, being capable of vertically sliding into longitudinal sliding trough 12 of transfer frame body 1 and fastening or detachable from sliding trough 12 by releasing the fastener.

2. A transfer apparatus of detachable disk drive as claim 1, wherein the backend of detachable support seat 2 is a support plate 20 which is capable of fixing the hard disk drive upon the central interior, both sides of support plate 20 place guiding rails 21 wherein one side fixes a guiding light pillar 22, the front edge of support plate 20 fixes a front cover plate 24 by screw 23, the interior wall of front cover plate 24 places a sliding piece 25 which places a through hole 251 on one side and preserves a fastener hole 252 on the other side, the terminal part of push button 253 is capable of entering into through hole 251, push button 253 places a slanted pyramidal face 254, one outer edge of front cover plate 24 places a push button hole 241 and an axle hole 242, one side of the above push button 253 locates in push button hole 241, a rotating pull bar 26 places axle hole 261 on the above corresponding axle hole 242 of front cover plate 24 and is covered by an axle 262 with inserting a spring 263 to combine rotating pull bar 26 with front cover plate 24 and reveals the rotation, the interior wall of rotating pull bar 26 places a hook 264 on the corresponding position of fastener 252 of the above sliding piece 25 wherein one side places fastener 265 on fastener trough 14 on the above corresponding transfer frame body 1.
